(19) United States
(12) Patent Application Publication
(10) Pub. No.: US 2025/0369540 A1
(43) Pub. Date: Dec. 4, 2025

(54) GRAPHENE ENHANCED FUEL HOSE

(71) Applicant: Martinrea International US Inc., Aubrun Hills, MI (US)

(72) Inventors: Scott David Rier, Pinckney, MI (US); Murali S. Chandrasekhar, Rochester, MI (US); Cory Doble, Ortonville, MI (US)

(21) Appl. No.: 19/220,447

(22) Filed: May 28, 2025

Related U.S. Application Data
(60) Provisional application No. 63/654,250, filed on May 31, 2024.

(51) Int. Cl. F16L 11/04

(52) U.S. Cl. CPC F16L 11/04; F16L 2011/047

(57) ABSTRACT

A fuel hose having an inner layer of a thermoplastic elastomer with Graphene or Graphene Derivatives, along with an outer rubber jacket. The outer rubber jacket can include any of a thermoset chlorinated polyethylene elastomer, a chloropolyethylene elastomer, a chlorosulphonated polyethylene, an epichlorohydrin rubber, an ethylene acrylic elastomer or an acrylic rubber material. The inner layer can also include a heat resistant polyamide resin (PA9T material) and a thermoplastic elastomer enhanced with a Graphene or Graphene Derivative. The elastomer material can include any of a thermoplastic vulcanizate, a non-fluorinated elastomer, a fluorocarbon elastomer, a highly saturated nitrile rubber or a nitrile rubber. The outer rubber jacket can include any of a thermoplastic chlorinated polyethylene elastomer, a chloropolyethylene elastomer, a chlorosulphonated polyethylene, an epichlorohydrin rubber, an ethylene acrylic elastomer or an acrylic rubber material.

### CROSS REFERENCE TO RELATED APPLICATIONS

The present application claims priority of U.S. Ser. No. 63/654,250 filed May 31, 2024.

### FIELD OF THE INVENTION

The present invention relates generally to automotive fuel hose technology. More specifically, the present invention teaches an elastomeric fuel hose, which substitutes a fluoropolymer barrier layer having a high modulus of elasticity with a fluorinated thermoplastic elastomer enhanced with Graphene or any Graphene Derivative providing the barrier resistant aspects, along with an outer rubber jacket. The present invention further discloses an elastomeric fuel hose with a heat resistant polyamide resin combined with a fluorinated or non-fluorinated thermoplastic elastomer enhanced with Graphene or Graphene Derivatives for providing the barrier resistant aspects, along with the outer rubber jacket.

### BACKGROUND OF THE INVENTION

Current fuel hoses in the technical art use a fluoropolymer barrier layer for achieving permeation resistance to hydrocarbons. Typically, such barrier layers exhibit a high degree of modulus of elasticity, this contributing to increased insertion force and difficulty in sealing. As is further known, elastomers and thermoplastic elastomers on their own typically exhibit poor permeation resistance.

Addressing the known art, U.S. Pat. No. 11,719,365 to Hermann teaches a fuel hose having at least one barrier inner layer and outer layer, wherein the barrier inner layer is obtainable by extrusion of a mixture comprising a) at least one thermoplastic fluoropolymer, b) at least one fluororubber and a crosslinking agent and/or at least one fluororubber elastomer and c) at least one carbon filler selected from carbon black, in particular conductivity carbon black, graphene, carbon nanofillers, in particular carbon nanotubes, carbon nanohorns, or a combination thereof in an amount of 0.05% by weight to 20% by weight of the carbon filler(s), or irradiated PTFE, and vulcanization. The hose exhibits a high fuel, diesel and oil stability and dynamic capability.

WO 2022/179668 teaches a multi-layer fuel hose with low permeation and including at least one outer elastomer layer and inner layer of a tetrafluoroethylene/hexafluoropropylene/vinylidene fluoride terpolymer. An optional intermediate layer is also provided and the disclosure further teaches the use of additives including graphite, carbon nanotubes and carbon fibers.

US 2020/0317900 (Laborbe) teaches a fuel hose having an extruded inner rubber composition including an FKM fluoroelastomer with a filler and micronized powder of a fluorinated thermoplastic polymer which is dispersed in the fluoroelastomer. The filler material further references either of carbon black or graphite.

US 2016/0305581 (Fauble) teaches a fuel transport hose with an FKM inner layer, a CPT barrier layer and an intermediate tie layer of nitrile rubber or acrylic rubber.

US 2008/0053551 (Hatchett) teaches a fuel feed hose and a fuel vapor line hose having reduced fuel permeation comprises a conductive FKM inner tubular structure and a chlorinated polyethylene backing layer (this further including a reinforcement member which can be any synthetic or natural fiber). The hose optionally contains an adhesive layer between the conductive FKM inner layer and the chlorinated polyethylene backing layer. Furthermore, the hose optionally contains a reinforcement member and a cover over the reinforcement member. A method of forming such tubular structures is also included.

US 2006/0099368 to Park teaches a multilayer fuel hose fluoropolymer inner layer of a continuous polymeric phase and a dispersed phase of conductive particulate provides electrical resistivity for avoiding electrical charge buildup from fuel flow within the fuel line. Fluoroelastomer fluoropolymer inner layers also provide flexibility and compressive sealing against rigid tubes connected to the multi-layer fuel line.

U.S. Pat. No. 11,795,313 (Park) discloses a rubber composition for a fuel-cell cooling hose including a base resin including an ethylene-propylene-diene monomer (EPDM); a reinforcing agent; an activating agent; a plasticizer; and a crosslinking agent.

Current fuel hoses in the technical art also use a fluoropolymer barrier layer for achieving permeation resistance to hydrocarbons. Typically, such barrier layers exhibit a high degree of modulus of elasticity, this contributing to increased insertion force and difficulty in sealing. As is further known, elastomers and thermoplastic elastomers on their own typically exhibit poor permeation resistance.

Addressing the known art, U.S. Pat. No. 6,805,168 discloses a multilayer hose, especially for conveying fuel, including an outer layer and a conductive, fluorine-containing, elastomeric inner layer mixed with graphite.

US 2010/0300571 teaches a flexible hose or a tubing having a barrier layer of polyamide 6 having branched molecular structure and an impact modifier, and/or a flexural modulus of 1 to 2 GPa and a tensile elongation of 100% or more. The hose may have additional layers such as an inner tube, an outer cover, a textile or wire reinforcement, or the like. Permeability to ethanol- and methanol-containing fuels is very low.

U.S. Pat. No. 11,719,364 discloses a hose having at least one barrier layer inner layer and an outer layer, wherein the barrier layer is obtainable by extrusion of a mixture including a) at least one thermoplastic fluoropolymer, b) at least one fluororubber and a crosslinking agent and/or at least one fluororubber elastomer and c) at least one carbon filler selected from carbon black, in particular conductivity carbon black, graphene, carbon nanofillers, in particular carbon nanotubes, carbon nanohorns, or a combination thereof in an amount of 0.05% by weight to 20% by weight of the carbon filler(s), or irradiated PTFE, and vulcanization. The hose exhibits a high fuel, diesel and oil stability and dynamic capability.

US 2008/0053551 teaches a fuel feed or fuel vapor line hose having reduced fuel permeation hose construction, wherein the tubular structure includes a conductive, FKM fluoropolymer inner layer having an inner surface and an outer surface and a chlorinated polyethylene backing layer around said fluoropolymer inner layer.

U.S. Pat. No. 6,435,217 teaches a multilayer pipe (1) for conducting hydrocarbons and including an inner layer (2) of an elastomeric material including a fluorine-containing elastomer mixed with graphite, a barrier layer including a polyamide (3), a reinforcing spun fabric (5) and an elastomeric outer covering layer (6), the latter including at least one material selected from the group consisting of chlorosulfonated polyethylene, chlorinated polyethylene, acrylonitrile/butadiene, PVC mixtures, EPDM chloroprene, EVA and EVM.

U.S. Pat. No. 6,602,565 discloses a method of producing a fuel hose including a plasma-treating a peripheral surface of a tubular fluororesin inner layer, treating a surface layer of the plasma-treated peripheral surface with water and forming a polyamide resin outer layer on the treated peripheral surface.

Finally, U.S. Pat. No. 10,036,491 teaches a flexible fuel hose for any biofuel or alcohol-containing fuel including non-fluoropolymer based layers and having a barrier layer of polyamide 6 having an impact modifier, and/or branched molecular structure, a flexural modulus of 1 to 2 GPa and/or a tensile elongation of 100% or more. The hose may have additional layers such as an HNBR rubber inner tube, an EVM/CPE rubber blend outer cover, a textile or wire reinforcement, or the like. Permeability to ethanol- and methanol-containing fuels is very low. Permeability to B20 biofuels is very low.

### SUMMARY OF THE INVENTION

The present invention discloses an elastomeric fuel hose, which substitutes a fluoropolymer barrier layer having a high modulus of elasticity with a fluorinated thermoplastic elastomer enhanced with Graphene inner layer and an outer rubber jacket layer. The inner layer can include a thermoplastic elastomer (TPE), such as including a fluoroelastomer (FKE) or ethylene tetrafluoroethylene (ETFE) with Graphene. The outer rubber jacket can include a variety of materials not limited to a thermoset chlorinated polyethylene elastomer (CPE), a Chloropolyethylene elastomer (CM), a chlorosulphonated polyethylene (CSM), an epichlorohydrin rubber (ECO), an ethylene acrylic elastomer (AEM) or an acrylic rubber material (ACM).

The present invention also discloses an elastomeric fuel hose, which combines a heat resistant polyamide resin, such as a Polyamide 9T or PA9T, with a non-fluorinated thermoplastic elastomer enhanced (TPE) or thermoplastic vulcanization (TPV) with Graphene for providing the barrier resistant aspects, along with an outer rubber jacket layer. The elastomer can further include any of a fluorocarbon elastomer (FKM), a highly saturated nitrile rubber (HNBR) or a nitrile rubber (NBR). The outer rubber jacket can include a variety of materials not limited to a thermoplastic chlorinated polyethylene elastomer (CPE), a Chloropolyethylene elastomer (CM), a chlorosulphonated polyethylene (CSM), an epichlorohydrin rubber (ECO), an ethylene acrylic elastomer (AEM) or an acrylic rubber material (ACM).

The Graphene further includes any Graphene derivative not limited to monolayer Graphene, few layered Graphene, fluorinated Graphene, functionalized Graphene, Graphene oxide and reduced Graphene oxide. Additionally, the Graphene can be compounded with the inner layer at any suitable range or ratio, such as 0.01-60% by weight.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective illustration of a fuel hose according to a non-limited embodiment of the present invention and which discloses an inner layer of a thermoplastic elastomer (TPE), such as including a fluoroelastomer (FKE) or ethylene tetrafluoroethylene (ETFE) with graphene or graphene derivatives, along with an outer rubber jacket including any of a thermoset chlorinated polyethylene elastomer (CPE), a chloropolyethylene elastomer (CM), a chlorosulphonated polyethylene (CSM), an epichlorohydrin rubber (ECO), an ethylene acrylic elastomer (AEM) or an acrylic rubber material (ACM); and

FIG. 2 is a perspective illustration of a fuel hose according to a non-limited embodiment of the present invention and which combines a heat resistant polyamide resin, such as a Polyamide 9T or PA9T, with a non-fluorinated thermoplastic elastomer enhanced (TPE) or thermoplastic vulcanization (TPV) with Graphene or Graphene Derivatives for providing barrier resistant aspects, along with an outer rubber jacket layer including any of a thermoplastic chlorinated polyethylene elastomer (CPE), a Chloropolyethylene Elastomer (CM), a chlorosulphonated polyethylene (CSM), an epichlorohydrin rubber (ECO), an ethylene acrylic elastomer (AEM) or an acrylic rubber material (ACM).

### DETAILED DESCRIPTION OF THE PREFERRED EMBODIMENTS

With reference to the attached illustrations, the present invention discloses an elastomeric fuel hose, which substitutes a fluoropolymer barrier layer having a high modulus of elasticity with a fluorinated thermoplastic elastomer enhanced with Graphene or Graphene Derivatives and an outer rubber jacket.

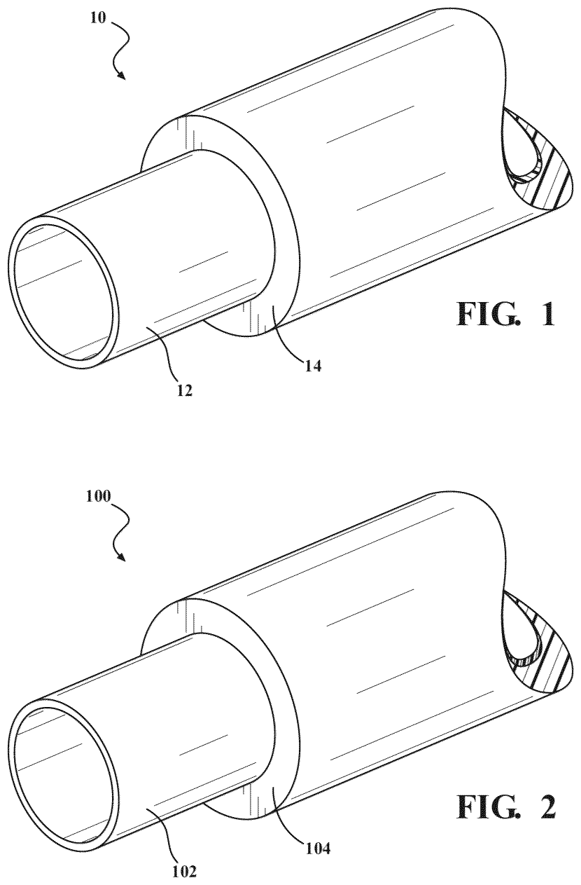

Referring to FIG. 1, a perspective illustration is generally shown at 10 of a fuel hose according to a non-limited embodiment of the present invention and which discloses an inner layer 12 of a thermoplastic elastomer (TPE), such as including a fluoroelastomer (FKE) or ethylene tetrafluoroethylene (ETFE) with Graphene or Graphene Derivatives, along with an outer rubber jacket 14. The outer rubber jacket 14 can include a variety of materials not limited to a thermoset chlorinated polyethylene elastomer (CPE), a chloropolyethylene elastomer (CM), a chlorosulphonated polyethylene (CSM), an epichlorohydrin rubber (ECO), an ethylene acrylic elastomer (AEM) or an acrylic rubber material (ACM). In this manner, the use of Graphene or Graphene Derivatives is key in reducing permeation of the hydrocarbon being transported through the hose, thereby allowing the use of an elastomeric material without a separate barrier layer.

As previously noted, the Graphene further includes any Graphene derivative not limited to monolayer Graphene, few layered Graphene, Graphene oxide, fluorinated Graphene, functionalized Graphene and reduced Graphene oxide. Additionally, the Graphene can be compounded with the inner layer at any suitable range or ratio, such as 0.01-60% by weight.

Referring to FIG. 2, a perspective illustration is generally shown at 100 of a fuel hose according to a non-limited embodiment of the present invention and which discloses an inner layer 102 along with an outer rubber jacket 104.

The inner layer 102 combines a heat resistant polyamide resin, such as a Polyamide 9T or PA9T which is a proprietary polyamide resin, with a non-fluorinated thermoplastic elastomer enhanced (TPE) or thermoplastic vulcanization (TPV) with Graphene for providing barrier resistant aspects. The elastomer can further include any of a fluorocarbon elastomer (FKM), a highly saturated nitrile rubber (HNBR) or a nitrile rubber (NBR). As is further known, PA9T is highly resistant to heat, water, and abrasion, yet easily molded. When compared to other heat resistant polyamides, it has several superior features such as low moisture absorption, and superior dimensional stability.

Similar to FIG. 1, the Graphene further includes any Graphene derivative not limited to monolayer Graphene, few layered Graphene, fluorinated Graphene, functionalized Graphene, Graphene oxide and reduced Graphene oxide. Additionally, the Graphene can be compounded with the inner layer at any suitable range or ratio, such as 0.01-60% by weight.

The outer rubber jacket layer 104 includes any of a thermoplastic chlorinated polyethylene elastomer (CPE), a chloropolyethylene material (CM), a chlorosulphonated polyethylene (CSM), an epichlorohydrin rubber (ECO), an ethylene acrylic elastomer (AEM) or an acrylic rubber material (ACM). In this manner, the use of Graphene is key in reducing permeation of the hydrocarbon being transported through the hose, thereby allowing the use of a non-fluorinated thermoplastic elastomeric material as a barrier layer.

Having described my invention, other and additional preferred embodiments will become apparent to those skilled in the art to which it pertains, and without deviating from the scope of the appended claims. The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

The foregoing disclosure is further understood as not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosure. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

1. A fuel hose, comprising:
a fluorinated thermoplastic elastomer inner layer enhanced with a Graphene; and
an outer rubberized jacket layer.

2. The fuel hose of claim 1, said inner layer further comprising a thermoplastic elastomer.

3. The fuel hose of claim 2, said thermoplastic elastomer further comprising a fluoroelastomer.

4. The fuel hose of claim 2, said thermoplastic elastomer further comprising ethylene tetrafluoroethylene.

5. The fuel hose of claim 1, said outer rubberized jacket layer further comprising a thermoset chlorinated polyethylene elastomer.

6. The fuel hose of claim 1, said outer rubberized jacket layer further comprising a chloropolyethylene elastomer.

7. The fuel hose of claim 1, said outer rubberized jacket layer further comprising a chlorosulphonated polyethylene.

8. The fuel hose of claim 1, said outer rubberized jacket layer further comprising an epichlorohydrin rubber.

9. The fuel hose of claim 1, said outer rubberized jacket layer further comprising an ethylene acrylic elastomer.

10. The fuel hose of claim 1, said outer rubberized jacket layer further comprising an acrylic rubber material.

11. The fuel hose of claim 1, said Graphene further comprising any Graphene derivative not limited to monolayer Graphene, few layered Graphene, Graphene oxide, Fluorinated graphene, functionalized graphene, and reduced Graphene oxide.

12. The fuel hose of claim 1, further comprising said Graphene being compounded with said fluorinated thermoplastic elastomer inner layer at 0.01-60% by weight.

13. A fuel hose, comprising:
an inner layer including a heat resistant polyamide resin and a thermoplastic elastomer enhanced with a Graphene; and
an outer rubberized jacket layer.

14. The fuel hose of claim 13, said heat resistant polyamide resin further comprising a PA9T material.

15. The fuel hose of claim 13, said thermoplastic elastomer further comprising any of a thermoplastic vulcanizate, a nitrile rubber, a highly saturated nitrile rubber, a fluorocarbon elastomer or a non-fluorinated elastomer.

16. The fuel hose of claim 13, said outer rubberized jacket layer further comprising any of a thermoplastic chlorinated polyethylene elastomer, a chloropolyethylene material, an epichlorohydrin rubber, an ethylene acrylic elastomer, an acrylic rubber material or a chlorosulphonated polyethylene.

17. The fuel hose of claim 13, said Graphene further comprising any Graphene derivative not limited to monolayer Graphene, few layered Graphene, fluorinated Graphene, functionalized Graphene, Graphene oxide and reduced Graphene oxide.

18. The fuel hose of claim 13, further comprising said Graphene being compounded with said inner layer at 0.01-60% by weight.
